(19) United States
(12) Patent Application Publication
(10) Pub. No.: US 2016/0176329 A1
(43) Pub. Date: Jun. 23, 2016

(54) Floor mat

(71) Applicant: Peter B. Aronow, East Hampton, NY (US)

(72) Inventor: Peter B. Aronow, East Hampton, NY (US)

(21) Appl. No.: 14/757,771

(22) Filed: Dec. 23, 2015

Related U.S. Application Data
(60) Provisional application No. 62/096,405, filed on Dec. 23, 2014.

(51) Int. Cl. B60N 3/04

(52) U.S. Cl. CPC B60N 3/048; B60N 3/044

(57) ABSTRACT

A floor mat includes an internal space that can be filled with a fluid, such as water, air, or the like. The internal space can be filled and emptied as needed, permitting the floor mat to be conveniently moved and stored. Unlike conventional gel mats that can be heavy and bulky, the present floor mat provides the benefits of a fluid filled mat, while allowing users to significantly reduce the bulk of the floor mat when desired by removing the fluid therefrom.

### CROSS-REFERENCE TO RELATED APPLICATIONS

This application claims the benefit of U.S. provisional patent application No. 62/096,405, filed Dec. 23, 2014, the contents of which are herein incorporated by reference.

### BACKGROUND OF THE INVENTION

The present invention relates to a floor mat and, more particularly, to a floor mat that can be filled with a fluid and emptied for convenient moving and/or storage.

Conventional liquid or gel filled floor mats can be comfortable for use, but may be heavy, difficult to move, and may take up significant space for storage.

Conventional filled floor mats are also often expensive, not only to purchase, but also to ship.

As can be seen, there is a need for a floor mat that may be filled with a fluid and emptied as desired by the user. Such a floor mat may be relatively inexpensive and economical to manufacture, store and ship.

### SUMMARY OF THE INVENTION

In one aspect of the present invention, a floor mat comprises a bladder portion; and a fill/drain port for disposing a fluid into and removing the fluid from the bladder portion.

In another aspect of the present invention, a floor mat comprises a bladder portion; a fill/drain port for disposing a fluid into and removing the fluid from the bladder portion; a covering over at least a top portion of the bladder portion; and an anti-slip material over a bottom portion of the floor mat.

In a further aspect of the present invention, a method for protecting a portion of a floor of a vehicle comprises opening a fill/drain port on a floor mat; disposing a fluid into the fill/drain port to fill a bladder portion of the floor mat; and placing the floor mat over the portion of the floor of the vehicle.

These and other features, aspects and advantages of the present invention will become better understood with reference to the following drawings, description and claims.

### BRIEF DESCRIPTION OF THE DRAWINGS

FIG. 1 is a top view of a floor mat according to an exemplary embodiment of the present invention;

FIG. 2 is a cross-sectional view of the floor mat of FIG. 1, taken along line 2-2 of FIGS;

FIG. 3 is a top view of a floor mat according to an exemplary embodiment of the present invention, with the covering removed therefrom.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention provides a floor mat that includes an internal space that can be filled with a fluid, such as water, air, or the like. The internal space can be filled and emptied as needed, permitting the floor mat to be conveniently moved and stored. Unlike conventional gel mats, that can be heavy and bulky, the floor mat of the present invention provides the benefits of a fluid filled mat, while allowing users to significantly reduce the bulk of the floor mat when desired by removing the fluid therefrom.

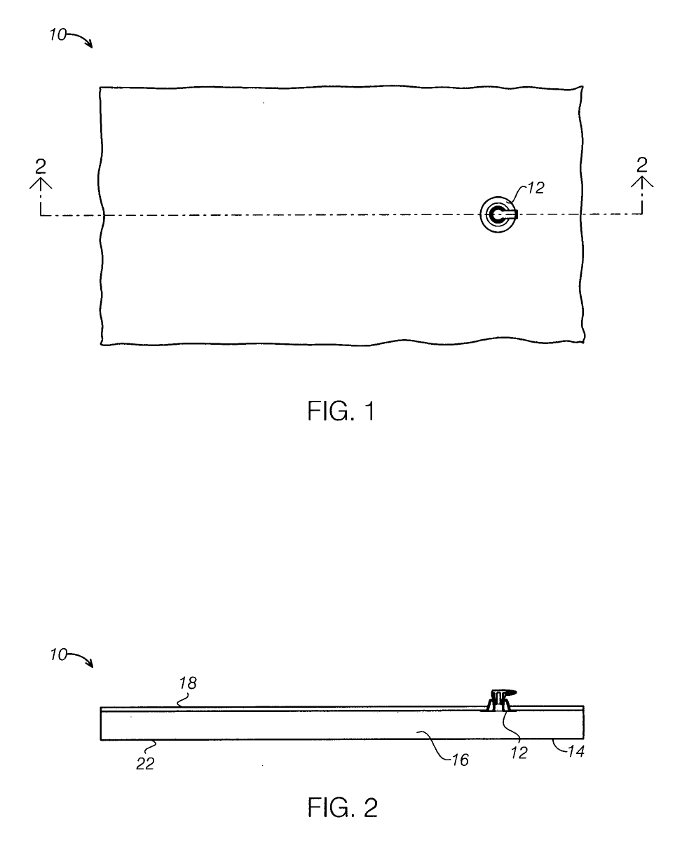

Referring to FIGS. 1 and 2, a floor mat 10 can include a bladder portion 14 that has an internal space 16 that can be filled with a fluid, such as water, air, or the like, and drained, as desired. A fill/drain port 12 can be provided in the floor mat 10 to permit access to the internal space 16 and to prevent the fluid from leaking out of the internal space 16 when the floor mat 10 is in use.

In some embodiments, a fluid holding material may be included within the bladder portion 14. The fluid holding material may be a material that absorbs fluid or may simply be one or more baffles, or the like. This substance may be any material capable of absorbing a fluid, such as a sponge-like material. When the fluid is a liquid, for example, the absorbing substance may help prevent the liquid from moving back and forth within the bladder portion 14 and also help dampen motion of the floor mat 10 when one portion is pressed upon.

In some embodiments, the bladder portion 14 may be made integral with an upper and lower covering, where the covering may provide a region for the fluid (with or without the absorbing substance) to be disposed. In this embodiment, the floor mat 10 can be formed from a top covering and a bottom covering (often an anti-slip material, as discussed below), where the fluid is disposed therebetween. As used herein, the “bladder portion” 14 covers any embodiment with an interior space that can hold a fluid therein.

The fill/drain port 12 can be designed to permit the fluid to be delivered to the bladder portion 14 under a pressure. For example, when the fluid is air, the fill/drain port 12 may be a Schrader valve, or the like, to permit air to enter the bladder portion 14 and not escape unless the valve is intentionally opened. In some embodiments, a releasable check valve may be provided to prevent the fluid from escaping unintentionally after the bladder portion is filled. Other valves, such as one-way valves, two-way valves, pressure valves, auto-fill valves, self draining valves, and the like may be used and are completed within the scope of the present invention.

In some embodiments of the present invention, the bladder portion 14 may be filled with a fluid, such as air, carbon dioxide, or the like, via an auto-fill mechanism. Various mechanisms, as may be known in the art, can be used to automatically fill the bladder portion 14 with its fill fluid The auto-fill mechanism may include a release to allow the fluid to be discharged from the bladder portion 14. In this embodiment, the auto-fill mechanism, with its discharge, may be used in place of the fill/drain port 12. In some embodiments, both the auto-fill mechanism and the fill/drain port 12 may be present in the floor mat.

While the Figures show a rectangular floor mat, the floor mat of the present invention can be made in any geometrical or non-geometrical shape. Further, the floor mat may be made in any suitable size depending on application. In some embodiments, a thickness of the floor mat (the distance from the top to the bottom of the floor mat) could be from about ⅛ inch to about 2 inches, usually from about ¼ inch to about 1 inch. In some embodiments, a width of the floor mat may be from about 6 to about 72 inches, usually from about 6 to about 24 inches and a length of the floor mat may be from about 8 to about 60 inches, usually from about 8 to about 42 inches.

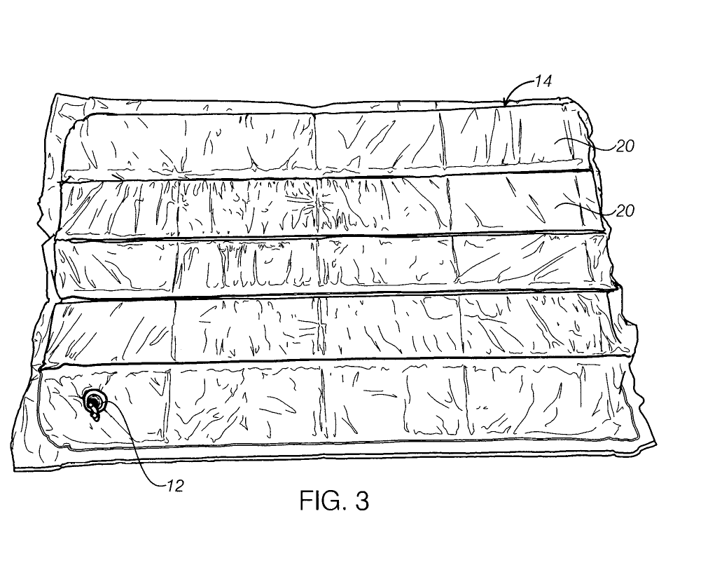

In some embodiments, as shown in FIG. 3, the bladder portion 14 may be made in multiple chambers 20. These chambers 20 may fill and drain with a single fill/drain port 12 or, in some embodiments, each of the chambers 20 may have their own fill/drain port 12. In the latter embodiments, the chambers 20 may be fluidly disconnected from each other. The chambers 20 may be designed to run parallel to each other, as shown, or may run at various angles, depending on the overall design of the floor mat 10. The top covering 18 may be attached to the bladder portion 14 or may be removable therefrom.

While the Figures show a single fill/drain port 12 located toward one end of the floor mat 10, multiple fill/drain ports may be disposed in a single floor mat. Moreover, the location of the fill/drain port 12 may be provided at any location provided that it allows a user to access the internal space 16 of the floor mat 10. For example, the fill/drain port 12 may be disposed in one or more corners of the bladder portion 14 of the floor mat 10. The fill/drain port 12 typically is disposed to be flush with the surface of the bladder portion 14. The fill/drain port 12 can be a threaded member, a twist-lock member, a friction fit member, or any like mechanism that prevents leakage from the bladder portion 14 and provides access to the internal space 16 when desired for filling or draining the bladder portion 14.

In some embodiments, at least a top surface of the floor mat 10 can be covered with a top covering 18. The top covering 18 may be one or more layers of foam, fabric, rubber, or the like, that may provide increased friction, comfort for the user, or the like. In some embodiments, the bottom surface of the floor mat 10 can have an anti-slip coating 22. This coating may be, in some embodiments, incorporated into the material used to fabricate the bladder portion 14 or may be attached to the bladder portion 14 or may be simply placed atop the bladder portion 14. The floor mat 10 can be made in various thicknesses, and the overall thickness of the floor mat 10 can include the bladder portion 14 and any top covering 18.

The bladder portion 14 of the floor mat 10 may be made from various materials, such as a plastic, vinyl, or the like. The bladder portion 14 may be made of a material that is flexible. In some embodiments, the bladder portion 14 may be made of a material that is flexible but does not stretch or expand under pressure. In this embodiment, foot pressure, for example, on the floor mat, would allow the foot to sink into the floor mat, but prevent the bladder portion 14 from expanding and allowing the foot to rest against the floor. In some embodiments, the internal space 16 may include baffles extending into the internal space, where the baffles may limit rapid movement of the fluid within the bladder portion 14.

The fill/drain port 12 can include a connection mechanism to attach to a filling and/or draining tube. For example, the full/drain port 12 can include hose threads, a quick disconnect coupling, a friction fit port, or the like, for attachment of a tube for ease of filling and/or draining the bladder portion 14 of the floor mat 10.

It should be understood, of course, that the foregoing relates to exemplary embodiments of the invention and that modifications may be made without departing from the spirit and scope of the invention as set forth in the following claims.

What is claimed is:

1. A floor mat comprising:
a bladder portion; and
a fill/drain port for disposing a fluid into and removing the fluid from the bladder portion.

2. The floor mat of claim 1, further comprising a covering over at least a top portion of the bladder portion.

3. The floor mat of claim 1, further comprising an anti-slip material over a bottom portion of the floor mat.

4. The floor mat of claim 1, wherein the bladder portion includes a plurality of chambers.

5. The floor mat of claim 4, wherein each of the plurality of chambers are fluidly connected.

6. The floor mat of claim 4, wherein each of the plurality of chambers are fluidly separate.

7. The floor mat of claim 6, wherein the fill/drain port includes a plurality of fill/drain ports for each of the chambers.

8. The floor mat of claim 1, further comprising an automated fill mechanism to automatically fill the bladder portion with a fluid.

9. The floor mat of claim 1, further comprising a fluid holding material disposed within the bladder portion.

10. A floor mat comprising:
a bladder portion;
a fill/drain port for disposing a fluid into and removing the fluid from the bladder portion;
a covering over at least a top portion of the bladder portion; and
an anti-slip material over a bottom portion of the floor mat.

11. The floor mat of claim 10, wherein the bladder portion includes a plurality of chambers.

12. The floor mat of claim 11, wherein each of the plurality of chambers are fluidly connected.

13. The floor mat of claim 11, wherein each of the plurality of chambers are fluidly separate.

14. The floor mat of claim 13, wherein the fill/drain port includes a plurality of fill/drain ports for each of the chambers.

15. A method for protecting a portion of a floor of a vehicle, comprising:
opening a fill/drain port on a floor mat;
disposing a fluid into the fill/drain port to fill a bladder portion of the floor mat; and placing the floor mat over the portion of the floor of the vehicle.

16. The method of claim 15, further comprising covering at least a top portion the bladder portion with a top covering member.

17. The method of claim 15, further comprising reducing slippage between the floor mat and the portion of the floor of the vehicle with an anti-slip material placed over a bottom portion of the floor mat.

18. The method of claim 15, wherein the bladder portion includes a plurality of chambers.

19. The method of claim 18, further comprising filling or draining each of the plurality of chambers with one fill/drain port.

20. The method of claim 18, further comprising filling or draining each of the plurality of chambers with a plurality of fill/drain ports, wherein each of the plurality of chambers are fluidly separate.
